(19) United States
(12) Patent Application Publication
(10) Pub. No.: US 2009/0259835 A1
(43) Pub. Date: Oct. 15, 2009

(54) SYSTEM AND METHOD FOR TRACKING AND RECORDING SYSTEM CONFIGURATIONS OF ELECTRONIC DEVICES

(76) Inventor: Chiy-Ferng Perng, Taipei City (TW)

Correspondence Address: NORTH AMERICA INTELLECTUAL PROPERTY CORPORATION, P.O. BOX 506, MERRIFIELD, VA, 22116, US

(21) Appl. No.: 12/420,062

(22) Filed: Apr. 8, 2009

(30) Foreign Application Priority Data
Apr. 11, 2008 (TW) 097113190

(51) Int. Cl. G06F 9/00

(52) U.S. Cl. 713/1

(57) ABSTRACT

A system for tracking and recording system configurations of an electronic device includes: a storage device; and a microprocessor, for checking whether a current system configuration of the electronic device is different from a first reference configuration of the electronic device, and storing the current system configuration into the storage device if the current system configuration is different from the first reference configuration.

### BACKGROUND OF THE INVENTION

1. Field of the Invention

The present invention relates to a system maintenance mechanism, and more particularly to a system having capability of tracking and recording system configurations of an electronic device (e.g. computer device).

2. Description of the Prior Art

A non-compatible peripheral device may cause a malfunction in a host system, so it is more efficient for engineers to understand a record of device swapping in order to figure out the malfunction. Alternatively, when more than one engineer performs maintenance of the same host system at a different time, the previous system configuration is very important information for each engineer who takes over the maintenance task. Even for reasons of updating a new version of firmware of a peripheral device, an exception of the host system may occur, and in such a case it is important to know the old version of firmware for debugging.

There are many prior art ways of recording system configurations of the host system and performing debugging detection. Please refer to FIG. 1, which illustrates a flow chart of the boot process regarding the conventional computer system. After power-on, a central processing unit (CPU) loads instructions from a boot area (usually starting at the address of FFFF0h) of a read-only memory (ROM) or a flash memory in order to execute codes of a basic input/output system (BIOS) to start the flow of the boot process. The BIOS then performs a power-on self test (POST) (Step 120) following power-on, and the system will test whether the peripheral hardware (e.g. memory, video card, hard disk drive, or communication port) is normal or whether the peripheral hardware exists. Finally, the result will be displayed on a monitor (if the video card is valid). Furthermore, the system may generate an error-detection code in this stage for debugging purposes. The often seen debug testing card for the motherboard employs the error-detection codes to know current problems encountered by hardware. If the above-mentioned test is normal, the system will find out the boot partition on the boot disk to go into the boot process of the operating system and hand over the control to the operating system in order to finish the boot process (Step 130).

In addition, Industries constitute a standard called “desktop management interface” (DMI) for convenience of the operating system and upper application programs managing the lower peripheral hardware. The information regarding peripheral hardware of the system is stored in a storage area of the BIOS in the format supported by this standard. This storage area is commonly named a management information format database (MIFD). Users can load and save information regarding the peripheral hardware via application programs. Detailed descriptions of the boot process and DMI are omitted here as they are well known to those skilled in the art. Although the current system configuration can be known by the conventional techniques mentioned above, information acquired is confined, and there is also no way to know changes of the components in the computer device (e.g. added, replaced or removed). Thus, a new system maintenance mechanism is desired in order to track and record the history of changes regarding the peripheral hardware.

### SUMMARY OF THE INVENTION

It is therefore one objective of the present invention to provide a system and method thereof for tracking and recording system configurations of the electronic devices.

A system for tracking and recording system configurations of an electronic device according to one exemplary embodiment of the present invention is provided. The system comprises: a storage device; and a microprocessor, for checking whether a current system configuration of the electronic device is different from a first reference configuration of the electronic device, and writing the current system configuration into the storage device if the current system configuration is different from the first reference configuration.

While the above-mentioned system of the present invention is provided, a method for tracking and recording system configurations of an electronic device is also provided, accordingly. The method comprises: checking whether a current system configuration of the electronic device is different from a first reference configuration of the electronic device; and storing the current system configuration when it is different from the first reference configuration.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flow chart of the boot process of the conventional computer system.

FIG. 2 is a block diagram of the system for tracking and recording system configurations of the electronic device according to one exemplary embodiment of the present invention.

FIG. 3 is a diagram of the system configuration storage area shown in FIG. 2.

FIG. 4 is a flow chart of operations of the system for tracking and recording system configurations according to one exemplary embodiment of the present invention.

### DETAILED DESCRIPTION

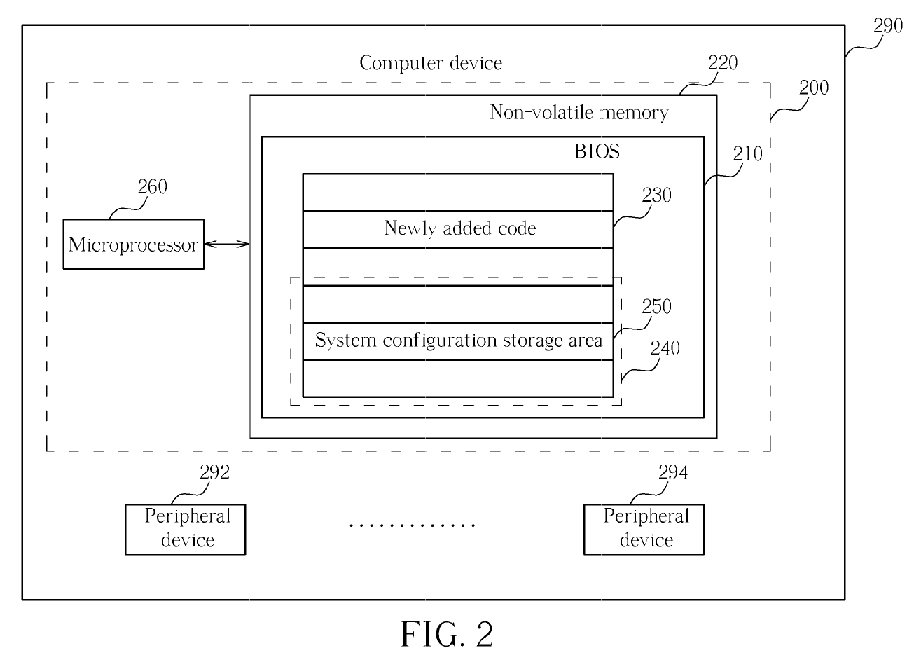

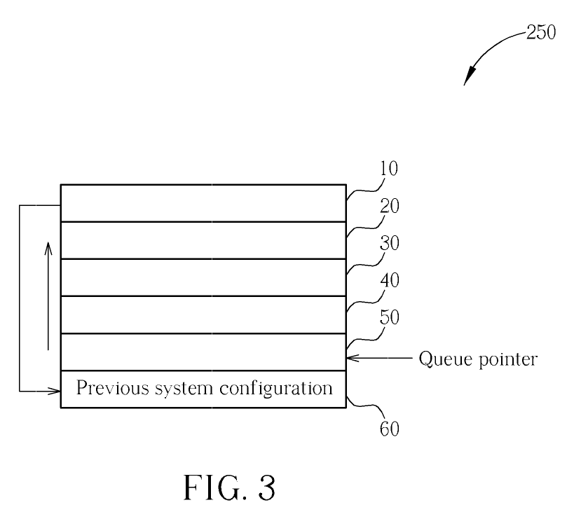

Please refer to FIG. 2 and FIG. 3. FIG. 2 illustrates a system 200 for tracking and recording system configurations of an electronic device according to one exemplary embodiment of the present invention. In this embodiment, system 200 is applied to tracking and recording system configurations of a computer device 290. Please note, however, that the above-mentioned embodiment is only for illustrative purposes and is not meant to be a limitation of the present invention. That is, the applications of the present invention are not merely limited to computer devices.

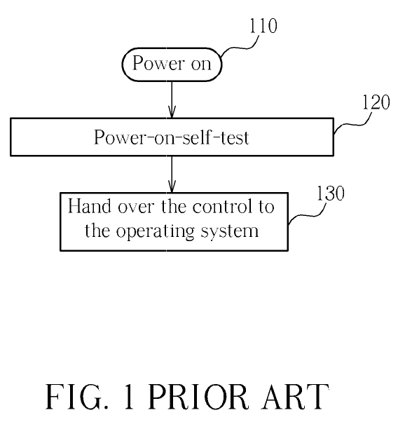

As shown in FIG. 1, the system 200 for tracking and recording system configurations of the computer device 290 comprises a storage device and a microprocessor, wherein the storage device is implemented with a non-volatile memory (e.g. flash memory) 220 and the microprocessor is implemented with a microprocessor 260. In addition, the non-volatile memory 220 and the microprocessor 260 are both disposed in a same motherboard. There is a basic input/output system (BIOS) 210 stored in the non-volatile memory 220. In this embodiment, a newly added code 230 is added into the BIOS in order to track and record system configurations of the computer device in the boot process. Each time the computer device 290 goes into the boot process, the microprocessor 260 executes general instructions required to be executed for the boot process as well as executing the newly added code 230 for storing a new system configuration into the system configuration storage area of the management information format database (MIFD) 240. Detailed function and operation of the newly added code 230 will be described later. In this embodiment, the content of the system configuration which has to be recorded comprises (but not limited to): device information regarding the motherboard and the peripheral devices (e.g. the peripheral device 292 and 294 shown in FIG. 2) such as the microprocessor 260, the system memory (not shown), and the video card. FIG. 3 is a diagram of the system configuration storage area 250. As shown in FIG. 3, the storage format of the system configuration storage area 250 is a circular queue, in which there are several storage blocks (e.g. the block 10 to the block 60).

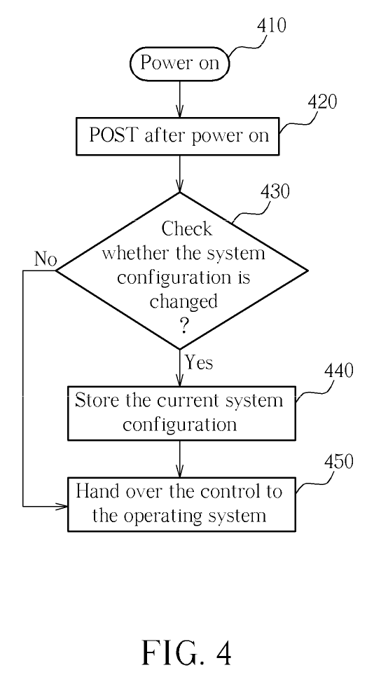

Please refer to FIG. 2 FIG. 4. FIG. 4 is a flow chart of operations of the system 200 tracking and recording the computer device 290.

Please note that the steps of the method for tracking and recording system configurations of the present invention are not limited to be executed according to the exact order shown in FIG. 4 provided the result is substantially the same. That is, the flow shown in FIG. 4 is only for explanatory purposes, not a limitation of the present invention. Besides, the flow chart shown in FIG. 4 only shows the steps relative to the present invention under the condition of not affecting the disclosure of the present invention.

Operations of tracking and recording system configurations of the present invention can be summed up as a resumptive form as follows:

Step 410: Power on;

Step 420: POST

Step 430: Check whether the current system configuration is the same as the previously recorded system configuration? If yes, go to Step 450; or, go to Step 440;

Step 440: Store the current system configuration into the system configuration storage area 250 of the MIFD 240;

Step 450: Hand over the control to the operating system and finish the boot process.

Compared to FIG. 1, the present invention further adds Step 430 and Step 440. These two steps entirely correspond to the newly added code 230, which is executed by the microprocessor 260. In Step 430, the newly added code 230 is executed by the microprocessor 260, for comparing the current system configuration with the previous system configuration. For instances, the current system configuration loaded by the computer device 290 will be compared with the system configuration last time stored in the system configuration storage area 250 (e.g. the system configuration stored in the block 60 of the circular queue 310) shown in FIG. 3. If the result indicates the two system configurations are different, it means that the user may change components of the computer device 290 (e.g. the peripheral device 292 is removed by the user or the user installs a new peripheral device), the newly added code 230 executed by the microprocessor 260 stores the current system configuration into a block according to the address indicated by the queue pointer (e.g. the block 50 of the circular queue 310), making a reference system configuration for the next boot process. Accordingly, the queue pointer will move to a next storage block (e.g. the block 40), and then Step 450 is executed, handing over the control to the operating system to finish this boot process.

On the other hand, if the result of the microprocessor 260 executing the newly added code 230 indicates that the current system configuration is the same as the reference system configuration (e.g. the system configuration stored in the block 60 of the circular queue 310), representing that there is no change in components of the computer device 290, the current system configuration need not be stored, and the process can jump directly to the Step 450 and hand over the control to the operating system.

Please note that the present invention employs the microprocessor 260 of the computer device 290 to execute a newly added code 230 in the BIOS 210 in order to store the system configuration into the system configuration storage area 250 of the MIFD 240 in the BIOS 210 with the standard of DMI.

The above is, however, just one implementation of the present invention, and not a limitation. For example, the system configuration is not limited to being stored into the same non-volatile memory 220 as the BIOS 210. In addition, when microprocessor 260 executes the newly added code 230 to go to Step 430, the current system configuration will be directly stored into system configuration storage area 250 and employed as a reference system configuration for a next boot process if there is no data stored in the system configuration storage area 250.

One advantage of the above-mentioned embodiment of the present invention is that each time the computer device goes into the boot process, the current system configuration will be automatically stored into the data storage area of DMI in the BIOS once the difference between the current system configuration and the system configuration previously stored is found. This saving of several system configurations means the complete history of the changes in the system configuration storage area can be known by engineers, thereby providing a reference for system maintenance.

Those skilled in the art will readily observe that numerous modifications and alterations of the device and method may be made while retaining the teachings of the invention.

What is claimed is:

1. A system for tracking and recording system configurations of an electronic device, comprising:
a storage device; and
a microprocessor, for checking whether a current system configuration of the electronic device is different from a first reference configuration of the electronic device, and writing the current system configuration into the storage device if the current system configuration is different from the first reference configuration.

2. The system of claim 1, wherein the microprocessor and the storage device are both installed in a same motherboard.

3. The system of claim 2, wherein the storage device has a basic input/output system (BIOS) and the microprocessor writes the current system configuration into a data storage area of a desktop management interface (DMI) in the BIOS when the current system configuration is different from the first reference configuration.

4. The system of claim 1, wherein the current system configuration comprises device information regarding the motherboard and at least one peripheral device, which is electrically connected to the motherboard.

5. The system of claim 1, wherein the microprocessor further checks whether a current system configuration of the electronic device is different from a second reference configuration of the electronic device in a previous boot process, and stores the current system configuration regarding the previous boot process into the storage device as the first reference configuration when the current system configuration regarding the previous boot process is different from the second reference configuration.

6. The system of claim 1, wherein the storage device records the system configuration of the electronic device written by the microprocessor by means of a circular queue.

7. The system of claim 1, wherein the microprocessor checks the system configuration of the electronic device for each boot process.

8. A method for tracking and recording system configurations of an electronic device, comprising:
checking whether a current system configuration of the electronic device is different from a first reference configuration of the electronic device; and
storing the current system configuration when it is different from the first reference configuration.

9. The method of claim 8, wherein the electronic device is a computer device that stores a BIOS, and the step of storing the current system configuration comprises:
writing the current system configuration into a data storage area of a desktop management interface (DMI) in the BIOS.

10. The system of claim 9, wherein the current system configuration comprises device information regarding the motherboard and at least one peripheral device, which is electrically connected to the motherboard.

11. The system of claim 8 further comprising:
checking whether a current system configuration of the electronic device is different from a second reference configuration of the electronic device in a previous boot process, and storing the current system configuration regarding the previous boot process as the first reference configuration when the current system configuration regarding the previous boot process is different from the second reference configuration.

12. The method of claim 8, wherein the current system configuration is stored by means of a circular queue.

13. The method of claim 8, wherein the method is executed for each boot process of the electronic device.
